(19) United States
(12) Patent Application Publication
(10) Pub. No.: US 2009/0100188 A1
(43) Pub. Date: Apr. 16, 2009

(54) METHOD AND SYSTEM FOR CLUSTER-WIDE PREDICTIVE AND SELECTIVE CACHING IN SCALABLE IPTV SYSTEMS

(75) Inventors: Qiang Li, Campbell, CA (US); Naxin Wang, Cupertino, CA (US); Li-Cheng Tai, San Jose, CA (US); Zhen Zeng, Fremont, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 11/870,563

(22) Filed: Oct. 11, 2007

(51) Int. Cl. G06F 15/16

(52) U.S. Cl. 709/231

(57) ABSTRACT

A method for caching of stream data is accomplished by assigning for each video segment in the system a likelihood rating of future showing and then determining for each node that contains a copy of the segment a second likelihood value that reflecting a probability that the node will be used to serve streams for the segment. The future cost value of a segment copy is then predicted and preload orders are issued to nodes for segments with the per-copy likelihood above a predefined threshold.

### REFERENCE TO RELATED APPLICATIONS

This application is related to copending applications Ser. No. 10/826,519 carrying attorney docket no. U001 100084 entitled METHOD AND APPARATUS FOR A LOOSELY COUPLED, SCALABLE DISTRIBUTED MULTIMEDIA STREAMING SYSTEM filed on Apr. 16, 2004 and Ser. No. 10/826,520 entitled METHOD AND APPARATUS FOR MEDIA CONTENT DISTRIBUTION IN A DISTRIBUTED MULTIMEDIA STREAMING SYSTEM carrying attorney docket no. U001 100085 filed on Apr. 16, 2004, both applications having a common assignee with the present application, the contents of which ate incorporated herein by reference.

### BACKGROUND OF THE INVENTION

1. Field of the Invention

This invention relates generally to the field of distributed multimedia streaming and more particularly to media content distribution for high bit rate streaming by employing caching of data in distributed stream serving nodes

2. Description of the Related Art

A scalable video streaming server as disclosed in copending application Ser. No. 10/826,519 entitled METHOD AND APPARATUS FOR A LOOSELY COUPLED, SCALABLE DISTRIBUTED MULTIMEDIA STREAMING SYSTEM filed on Apr. 16, 2004 can be employed with a cluster of a number of stream serving nodes and a controller which can serve more than ten thousand streams and hold terabytes of video data. The data are distributed among the stream serving nodes to enable the system to meet various degrees of demands as well as fault tolerance, and the placement is managed by the controller which may frequently replicate, move or delete copies of video programs in the cluster response to the dynamics of the requests from the clients (viewers). A stream can be served by different source nodes throughout its life time due to the way the referenced data were placed or replicated.

It is therefore desirable to make the stream play smoothly while accommodating trick mode commands such as change of play direction or speed, fast forwarding or rewind, which are impromptu decisions made by the stream viewer.

It is further desirable that when the stream is switched to a different node after the data for the current video segment is exhausted, the handoff is accomplished without introducing jitter into the playback independent of which node will be the next for the stream based on decisions by the controller.

### SUMMARY OF THE INVENTION

The present invention provides a method for caching of stream data accomplished by assigning for each video segment in the system a likelihood rating of future showing and then determining for each node that contains a copy of the segment a second likelihood value that reflecting a probability that the node will be used to serve streams for the segment. The future cost value of a segment copy is then predicted and preload orders are issued to nodes for segments with the per-copy likelihood above a predefined threshold.

### BRIEF DESCRIPTION OF THE DRAWINGS

These and other features and advantages of the present invention will he better understood by reference to the following detailed description when considered in connection with the accompanying drawings wherein:

FIG. 1 is a block diagram of a media station in a system incorporating the present invention;

FIG. 2 is a block diagram of data flow under the control of a media director for a system incorporating the present invention;

FIG. 3 is a flow diagram of media streaming control in a system incorporating the present invention;

FIG. 4 is a (low chart of controller actions for preloading streaming segments to data cache; and,

FIG. 5 is a block diagram of exemplary heuristic evaluation of the cost value and related likelihood for segment use from a media engine.

### DETAILED DESCRIPTION OF THE INVENTION

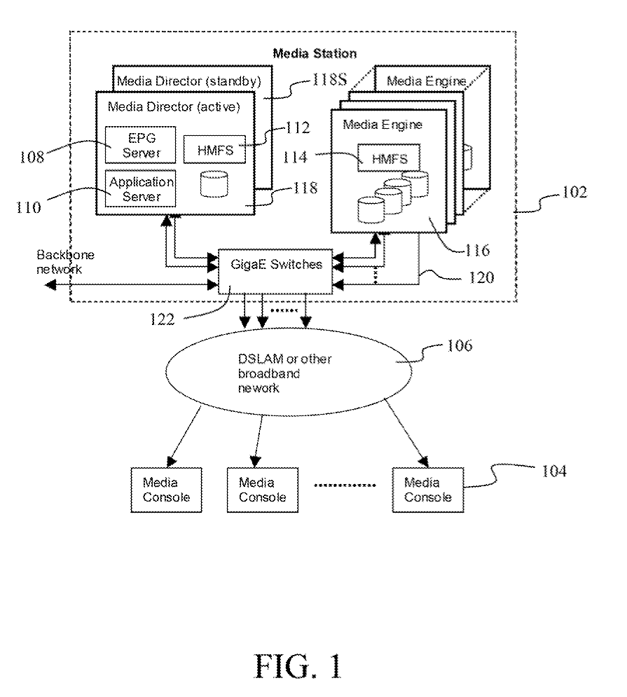

Streaming of data to clients is accomplished using video streaming server clusters in a system as shown in FIG. 1. For this exemplary embodiment, a media station 102 incorporates a controller or media director 118 having an EPG server 108 and an application server 110 for handling streaming and trick requests from the subscriber. A Hyper Media File System (HMFS) 112 is incorporated for data storage. A standby media director 118S with identical capabilities is provided to assume the role of the active director upon failure or removal from service. Multiple media servers or engines are clustered in the media station. The media director records the location of all programs in the system and which media engine holds a particular program or portions of it. Upon communication from a subscriber media console, the media director directs the media console to the appropriate media engine to begin the data stream. A distributed storage subsystem (for the embodiment shown, a HMFS) 114 is present in each media engine to employ large number of independent, parallel, I/O channels 120 to meet massive storage size demands and I/O data rate demands. Media engines are connected together through a set of Gigabit Ethernet switch 122, and to the network 106 communicating with the subscribers. Matching bandwidth between the network to subscribers and I/O channels avoids any bottleneck in the streaming system.

Each media program (a movie, a documentary, a TV program, a music clip, etc.) is partitioned into smaller segments as described in previously referenced application Ser. No. 10/826,519. Such partition provides a small granularity for media data units and makes data movement, replications, staging and management much easier and more efficient. For streaming content to subscribers, the media director in each of the media stations employs a load balancing scheme to keep track of the task load of the media engines in the media station. Load balance is achieved by directing streaming requests according to current system states and load distribution.

An example of the communications sequence for data transfer under the command of the media director is shown in FIG, 2 with representative IP address locations for the system elements. The media console 104 requests 802 a segment 0021 from the media director 118. The media director identifies the location of the segment in a segment location table 804 as present in media engines 1 and 8, (ME1 and ME8) and redirects 806 the MC to ME1's IP address 10.01.1.11. The MC then requests 808 segment 0021 from ME 1 which begins streaming data 810. When the segment being streamed nears its end, ME1 requests 812 the location of the next segment from the MD which locates the next segment and MEs storing that segment in the segment location table, selects an ME based on load and status and replies 814 with the identification of the next segment (seg 0022) and the IP address 10.0.1.12 of ME2 where the next segment resides. ME1 notifies ME2 to preload 816 the next segment seg 0022 and upon completion of the streaming of seg 0021 directs 818 ME2 to start streaming seg 0022 to IP address 18.0.2.15, the media console, ME2 then begins streaming 820 the data from seg 0022 to the MC.

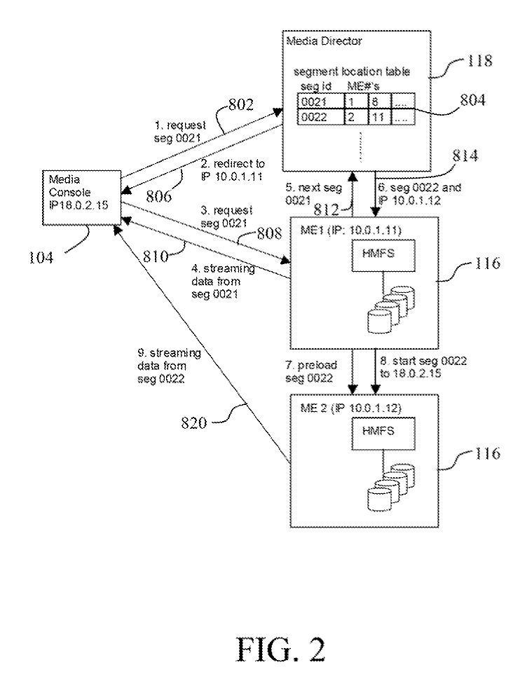

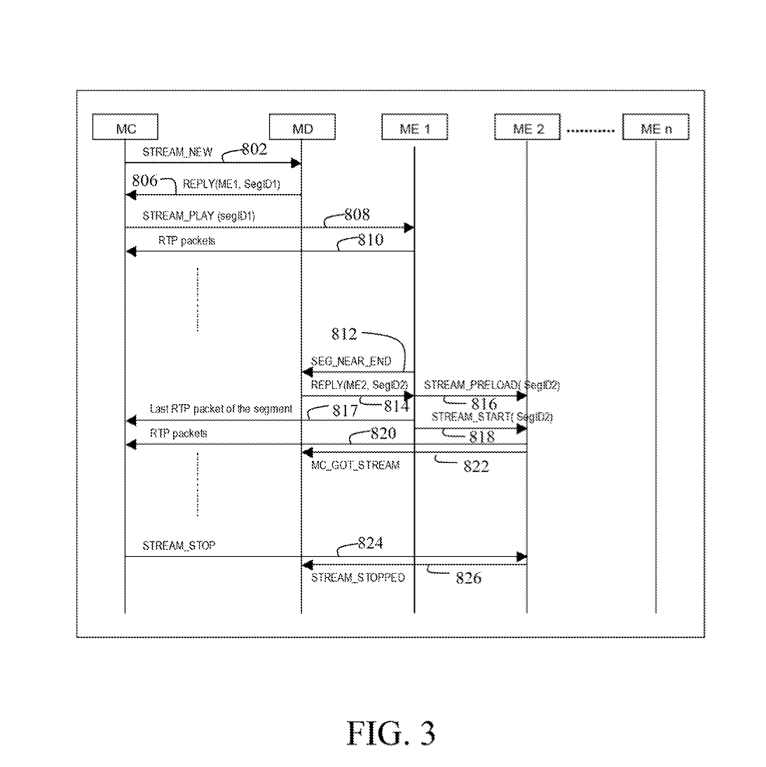

A flow diagram of the sequence described with respect to FIG. 2 is shown in FIG. 3. Upon assumption of the communication of the stream with the MC by ME2, ME2 sends a notification 822 to the MD. The process described continues until the MC orders a cessation of streaming 824 by the ME at which time the ME notifies the MD the streaming has stopped 826.

The present invention provides a prediction framework to allow the controller of the video streaming server cluster to predict the possible future locations of current streams and to issue preload orders to these nodes. This framework considers the existing traffic patterns and the popularity of particular video programs currently in demand and the current data placements in the cluster to achieve an accurate prediction of future traffic patterns which also allows flexibility to changes due to user behavior. It also maximizes system efficiency by grouping the streams on the same video data on the minimal number of nodes, therefore increasing system efficiency and the capacity to serve different video programs to other viewers

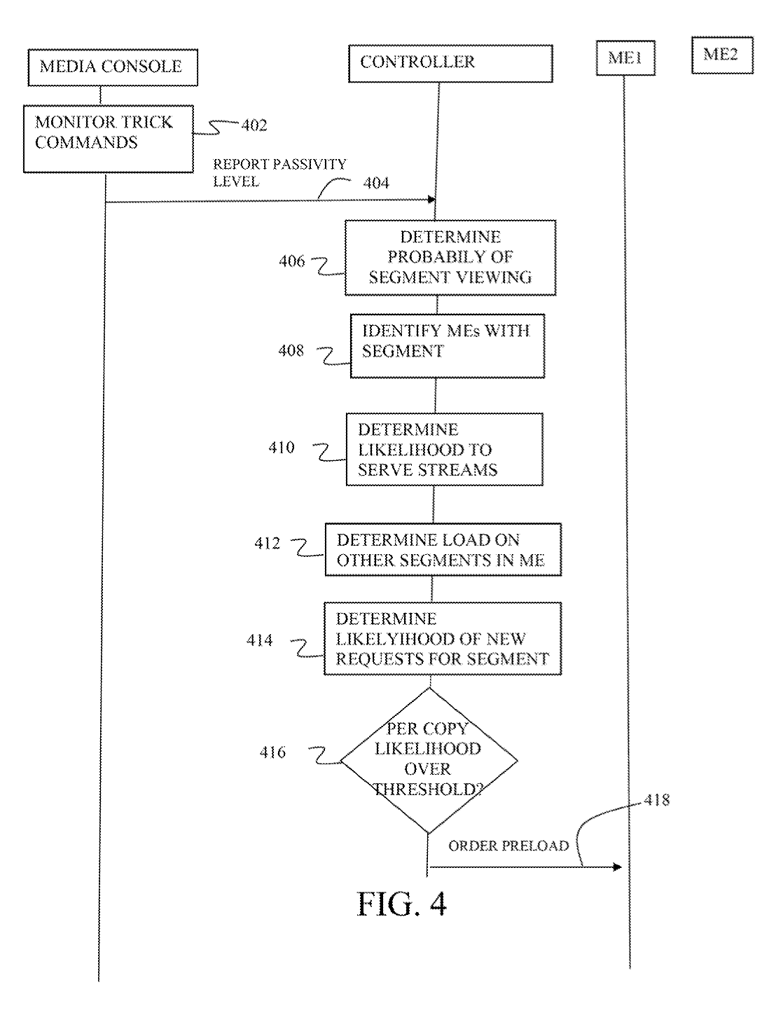

As shown for the method of the present invention in FIG. 4, for each stream the probability of sequential playing is determined 402, that is, the normal TV-style viewing behavior where the viewer is assessed as passive, the most desirable behavior for the purpose of prediction. Viewers who are constantly playing with their remotes and issuing rewind or fast forward requests will have the lowest degree of passiveness and they will be given the least consideration in the prediction. The “passiveness” or “activeness” of viewers are calculated towards the likelihood of next segment being viewed, thus being preloaded. Individual streams contribute to the likelihood, or unlikelihood. The serving nodes periodically report the passiveness of a stream 404 to the controller.

For each video segment in the system, a likelihood rating of being viewed in near future is assigned 406, that is, a measure that the segment will be watched. The more passive streams moving toward a segment, the higher the rating for the segment. Then for each segment all the media engine nodes are identified where a copy of this segment resides 408. Each node with such a copy is given a likelihood value that reflects the belief that it will be used to serve streams 410. Various factors are used to predict the future cost value of a node with such a segment copy serving imminent streams. The lower cost value, the higher likelihood of a node serving streams for that segment. These factors include but are not limited to, the possible streaming load that may be incurred by other segments residing on the same node as this segment 412, the number of streams that may move to the segment, and the possibility of new requests 414 also for the segment (as determined from other metadata about the video segment that it is a news program, etc). The likelihood prediction calculation closely resembles the strategy the controller uses to select the next node of a stream during node handoff, using the same set of factors. Then the controller issues preload orders 418 to nodes for segments with the per-copy likelihood above a certain threshold 416. An example of implementation of the logic described above for a segment with ID 256001 that is being viewed by the Media Consoles, each Console viewing this segment reports user's passiveness on this segment to the Controller as described previously. The Controller then calculates the likelihood P1 of the immediate next segment (ID 256002) being viewed by simply averaging out the total aggregated passiveness value reported by Media Consoles on segment 256001 as an example. The Controller then determines that both ME1 and ME2 have a copy of segment 256002. The controller then weighs the individual likelihood of each ME serving this segment. At this moment ME1 has the load of serving 100 streams and another 500 streams are moving towards ME1, while ME2 has the load of serving 200 streams and another 200 streams are moving towards ME2. In this case, ME1 would have higher likelihood P2 than ME2 to serve the segment 256002, given its lighter working load. When calculated, the likelihood of ME1 sewing segment 256002 would exceed a predefined threshold, and thus results in Controller sending a pre-load command to ME1 for loading segment 256002 into its memories.

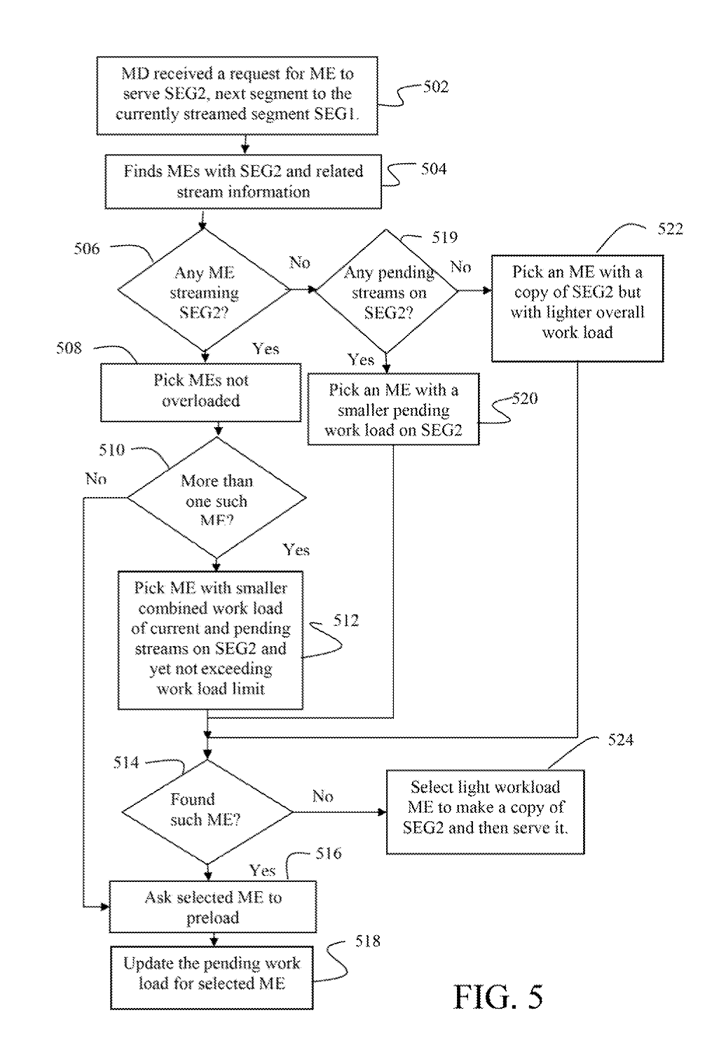

Heuristics are established to reduce the computation cost in the above process. For the exemplary embodiment disclosed herein, obtaining a reasonable but not necessarily the optimized prediction for each segment copy in each node is accomplished. This framework therefore increases the capability and flexibility of each streaming cluster system and improves service quality and viewer experience with moderate resource and computation costs. As shown in FIG. 5 for a method employing the present invention, during streaming of a segment SEG1 the MD receives a request for identification of a ME to stream the next segment SEG2 in step 502. The MD identifies all MEs which currently store SEG2 and their related stream information in step 504. A determination is made if any MEs are currently streaming segment SEG2 in step 506 and if so MEs which are not overloaded are identified in step 508. If more than one such ME exists as determined in step 510 then the ME with the smaller combined workload of current and pending streams of SEG2 that is not yet exceeding its workload limit is selected in step 512. A determination is made if a ME has been found in step 514 and if so, the ME is asked to preload SEG2 for streaming responsive to the requestor in step 516. The pending workload for that ME is then updated in step 518.

If in step 506 it was determined that no MEs were currently streaming segment SEG2 then a determination is made if any pending streams of SEG2 are present in step 519. A ME with a smaller pending work load on SEG2 is then identified and provided to step 514. Similarly, if no MEs having pending streams as determined in step 519, a ME which stores a copy of SEG2 but with the lighter overall workload is identified in step 522 and provided to step 514. If no ME with a copy of SEG2 is available then a ME with a light workload is selected copy SEG2 to act as the server for streaming to the requestor.

Having now described the invention in detail as required by the patent statutes, those skilled in the art will recognize modifications and substitutions to the specific embodiments disclosed herein. Such modifications are within the scope and intent of the present Invention as defined in the following claims.

What is claimed is:

1. A method for caching of stream data comprising the steps of;
assigning for each video segment in the system a likelihood rating of future showing;
determining for each node that contains a copy of the segment a second likelihood value that reflecting a probability that the node will be used to serve streams for tire segment;
predicting the future cost value of a segment copy; and,
issuing preload orders to nodes for segments with the per-copy likelihood above a predefined threshold.

2. The method defined in claim 1 wherein the step of predicting the future cost value includes die steps of;
determining the possible load on other segments on the same node;
determining the number of streams that may move to the segment; and
determining the possibility of new requests for the segment.

3. The method defined in claim 2 wherein the step of determining the possibility of new requests for the segment is determined from metadata about the video segment.

4. The method of claim 1 further comprising the steps of;
creating heuristics for the calculation of the first and second likelihood and future cost value;
employing the heuristics for reducing computation cost in issuing preload orders.

5. A method for caching of stream data comprising the steps of;
providing a media director;
providing a plurality of media engines in communication with the media director;
receiving during streaming of a segment SEG1 a request at the MD for identification of a ME to stream a next segment SEG2;
identifying all MEs which currently store SEG2 and their related stream information;
determining if any MEs are currently streaming segment SEG2;
responsive to a positive determination identifying MEs which are not overloaded;
determining if more than one such ME exists;
responsive to a positive determination selecting the ME with the smaller combined workload of current and pending streams of SEG2 that is not yet exceeding its workload limit;
determining if a ME has been selected;
responsive to a positive determination directing the selected ME to preload SEG2 for streaming responsive to the requestor;
updating the pending workload for the selected ME;
if a negative determination was made on MEs currently streaming segment SEG2 determining if any MEs with pending streams of SEG2 are present and, if so, selecting a ME with a smaller pending work load on SEG2 and proceeding to the step of determining if a ME has been selected;
if a negative determination was made on MEs with pending streams on SEG2 determining if a any MEs which store a copy of SEG2 are present and, if so, selecting one of those MEs with the lighter overall workload and proceeding to the step of determining if a ME has been selected;
if no ME with a copy of SEG2 is available then selecting a ME with a light workload to copy SEG2 and act as the server for streaming to the requestor.
